(19) United States
(12) Patent Application Publication
(10) Pub. No.: US 2018/0339572 A1
(43) Pub. Date: Nov. 29, 2018

(54) SYSTEM AND METHOD FOR DEFOGGING WINDOWS OF A MOTOR VEHICLE

(71) Applicant: FORD GLOBAL TECHNOLOGIES, LLC, Dearborn, MI (US)

(72) Inventors: Mukesh Kumar, Canton, MI (US); Robert Steven Sawyer, Farmington Hills, MI (US); Lawrence C. Karas, New Boston, MI (US); Andrew Dayton Phillips, Plymouth, MI (US)

(21) Appl. No.: 15/606,687

(22) Filed: May 26, 2017

(51) Int. Cl. B60H 1/00; F24F 3/14; B60H 3/02

(52) U.S. Cl. CPC B60H 1/00785; B60H 1/00878; F24F 3/14; F24F 3/12; B60H 1/00642; B60H 1/00735; B60H 1/00814; B60H 3/024

(57) ABSTRACT

A window defogging system for a motor vehicle includes an air source and a first air diffuser in communication with the air source. The first air diffuser includes a first plurality of air guides increasing in cross sectional area in proportion to increasing distance away from the air source. A related method of defogging motor vehicle windows is also disclosed.

### TECHNICAL FIELD

This document relates generally to the motor vehicle equipment field and, more particularly, to a new and improved system and method for defogging windows of a motor vehicle. Advantageously, the system and method are particularly useful for autonomous commercial vehicle applications.

### BACKGROUND

In commercial autonomous motor vehicles, there will be a continuing exchange of passengers entering and exiting the vehicles. This continuous change in occupants will often disrupt the controlled removal of moisture in the passenger compartment of the motor vehicle. For example, there is a possibility that each new occupant could introduce moisture laden clothes, boots and the like into the passenger compartment thereby increasing the tendency for the windows to fog up more easily and quickly. Thus, the challenge of maintaining clear windows is increased.

All passengers are likely to desire the windows to be clear and particularly in the bottom half of the window. Not having clear vision to the outside while moving may increase the tendency of one or more of the passengers to becoming carsick. Since there is no customer control of the climate system likely to be provided in autonomous commercial vehicles, automatic clearing of side window fogging would be expected. State of the art executions would have ducts located in the A pillars, B pillars and/or C pillars for directing air across the window surfaces. Significantly, the pillars rarely have the necessary cross sectional area required to carry the required volume of air at the rate required for quick and efficient clearing of large window surfaces. Thus, state of the art executions have limited viability in autonomous commercial vehicle applications and, accordingly, a new and true solution to the problem is required.

This document relates to a new and improved window defogging system that addresses and resolves these issues so as to provide a quick and effective way to clear motor vehicle windows of fog and even ice during inclement winter weather conditions.

### SUMMARY

In accordance with the purposes and benefits described herein, a new and improved window defogging system is provided for a motor vehicle. That window defogging system comprises an air source and a first air diffuser in communication with the air source. The first air diffuser includes a first plurality of air guides increasing in cross sectional area in proportion to increasing distance away from the air source.

The window defogging system may further include a second air diffuser. The second air diffuser may include a second plurality of air guides also increasing in cross sectional area in proportion to increasing distance away from the air source. In addition, the window defogging system may further include an air delivery conduit having a first end in communication with the air source and a second end in communication with the second air diffuser.

In one or more of the many possible embodiments of the window defogging system, the air source may be a heating, ventilating and air conditioning system (HVAC system) providing conditioned air for distribution through the first air diffuser and the second air diffuser.

The window defogging system may further include a control module. That control module may be configured to provide conditioned air through the first air diffuser and the second air diffuser in response to input data indicating at least one operating condition of window fogging and window icing. Toward this end, the control module may be connected to at least one device selected from a group consisting of an ambient humidity sensor, a passenger compartment humidity sensor, a precipitation sensor, an ambient temperature sensor, a passenger compartment temperature sensor, a window condition monitoring device and combinations thereof.

In one or more of the many possible embodiments, the first air diffuser may be positioned in a first door of the motor vehicle with the first plurality of air guides oriented along a first base of a first window of the first door. Further, the second air diffuser may be positioned in a second door of the motor vehicle with the second plurality of air guides oriented along a second base of a second window of the second door. In addition, the air delivery conduit may extend through the first door between the air source and the second air diffuser.

In accordance with an additional aspect, a new and improved method of window defogging is provided. That method comprises the steps of delivering air from an air source to a first air diffuser having a first plurality of air guides increasing in cross sectional area in proportion to increasing distance away from the air source and directing that air from the first plurality of air guides upwardly along a first base of a first window of a motor vehicle.

The method may further include the steps of delivering the air from the air source to a second air diffuser having a second plurality of air guides increasing in cross sectional area in proportion to increasing distance away from the air source and directing that air from the second plurality of air guides upwardly along a second base of a second window of the motor vehicle.

The method may also include the step of conditioning the air prior to delivering the air to the first air diffuser and the second air diffuser. In addition, the method may include the step of configuring a control module to deliver the air to the first air diffuser and the second air diffuser in response to input data indicating at least one operating condition of window fogging and window icing.

The method may also include the step of monitoring, by at least one device, at least one parameter selected from a group consisting of ambient humidity, passenger compartment humidity, current precipitation, ambient temperature, passenger compartment temperature, current window condition and combinations thereof.

Still further, the method may include the step of providing the first air diffuser in a first door of the motor vehicle. The method may also include the step of providing the second air diffuser in a second door of the motor vehicle. Still further, the method may include the step of conveying the air to the second air diffuser through an air delivery conduit in the first door.

In accordance with still another aspect, a motor vehicle is provided incorporating the window defogging system.

In the following description, there are shown and described several preferred embodiments of the window defogging system and the related method of defogging windows in a motor vehicle. As it should be realized, the system and method are capable of other, different embodiments and their several details are capable of modification in various, obvious aspects all without departing from the system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the window defogging system and the method of defogging windows of a motor vehicle and together with the description serve to explain certain principles thereof.

FIG. 1 is a schematic block diagram of the window defogging system.

FIG. 2 is a schematic illustration of a motor vehicle incorporating one possible embodiment of the window defogging system illustrated in FIG. 1.

FIG. 3 is a detailed schematic representation of the first air diffuser, the second air diffuser and the air delivery conduit for delivering air to the second air diffuser.

FIG. 4 is a schematic top plan view illustrating the first plurality of air guides and the second plurality of air guides both with increasing cross sectional area in proportion to increasing distance away from the air source.

Reference will now be made in detail to the present preferred embodiments of the window defogging system and related method, examples of which are illustrated in the accompanying drawing figures.

### DETAILED DESCRIPTION

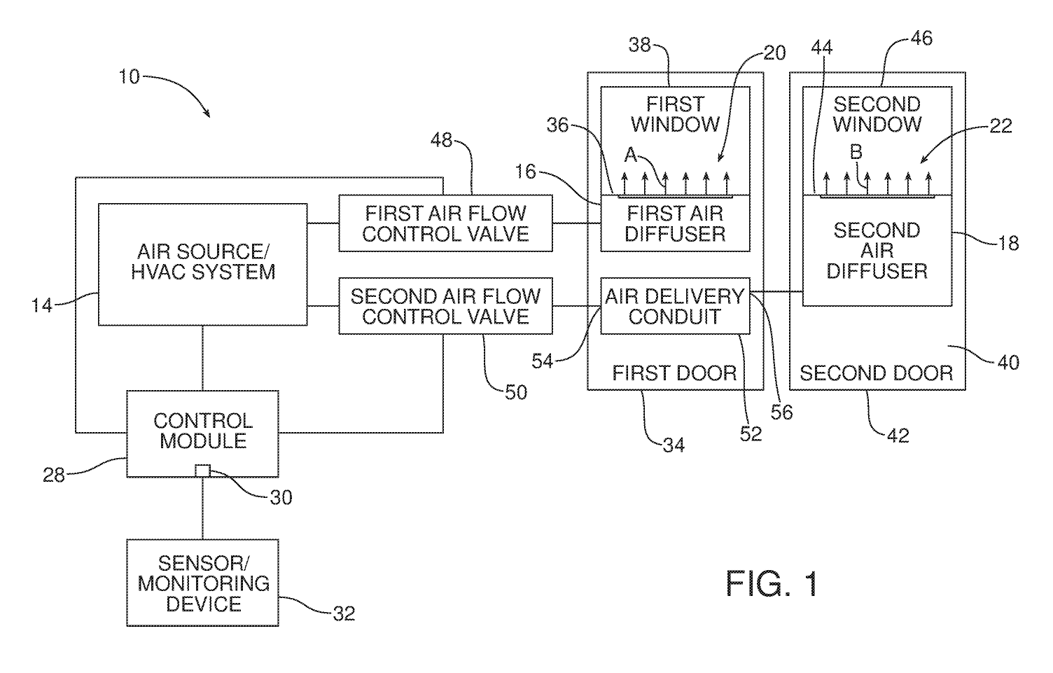

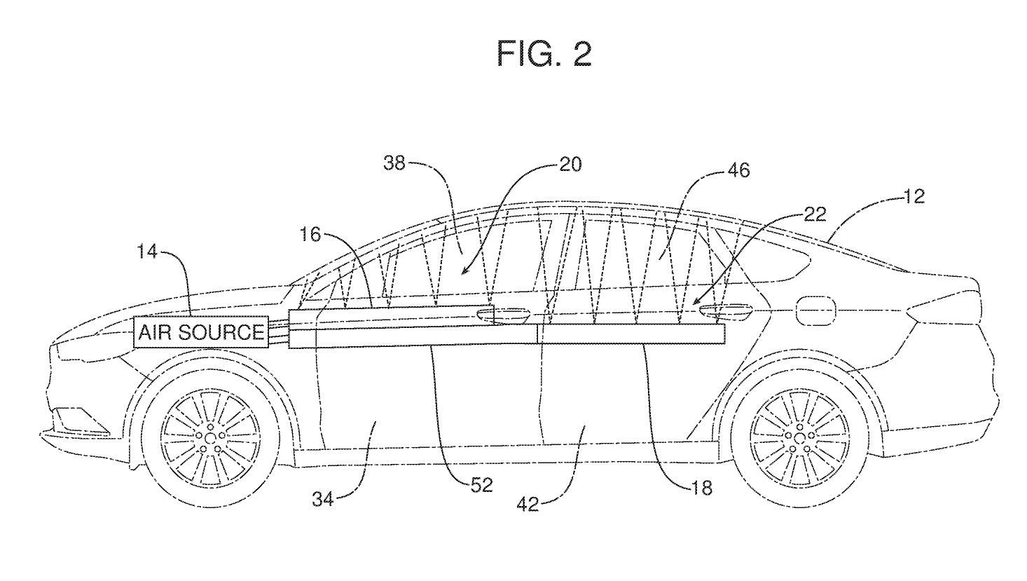

Reference is now made to FIGS. 1-4 illustrating the window defogging system 10 for a motor vehicle 12. The window defogging system 10 includes an air source 14 such as an HVAC system for generating conditioned air such as cold dehumidified air in the summer and warm dehumidified air in the winter.

The window defogging system 10 also includes a first air diffuser 16 in communication with the air source 14 and a second air diffuser 18 also in communication with the air source. The first air diffuser 16 includes a first plurality of air guides 20 while the second air diffuser 18 includes a second plurality of air guides 22. As will become apparent from the following description, the first plurality of air guides 20 and the second plurality of air guides 22 both increase in cross sectional area in proportion to increasing distance away from the air source 14.

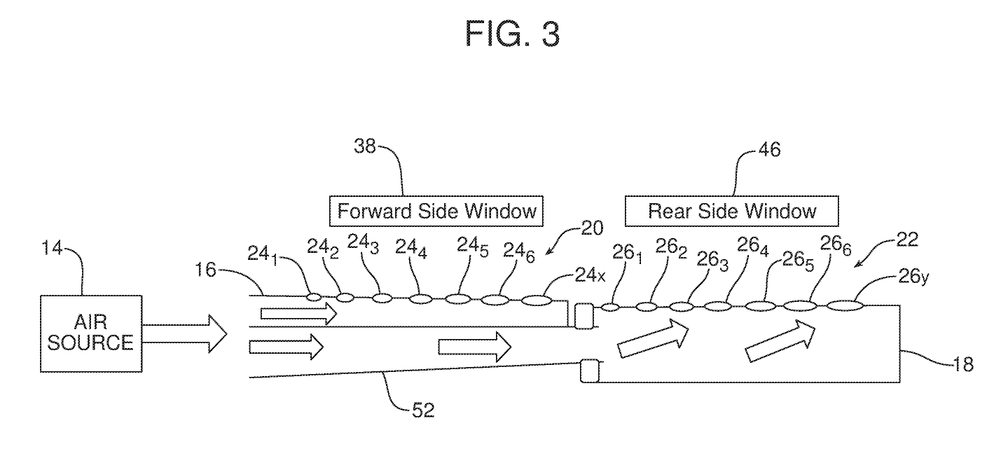

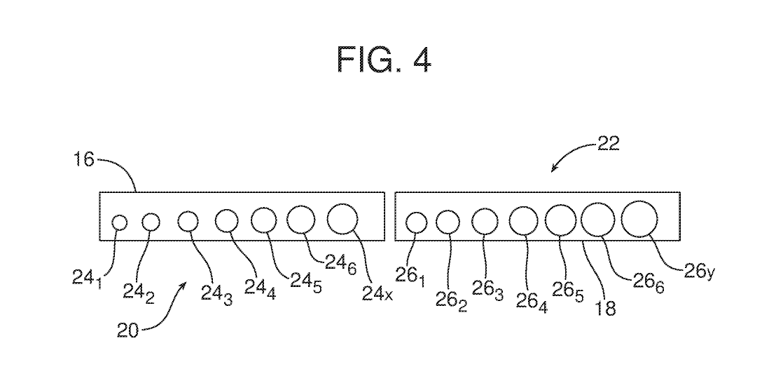

As illustrated in FIGS. 3 and 4, the first plurality of air guides 20 comprises X air discharge apertures 24₁-24ₓ that increase in size or cross sectional area as those apertures increase in distance from the air source 14. Similarly, the second plurality of air guides 22 comprises Y air discharge apertures 26₁-26_{y} that increase in size or cross sectional area with increasing distance from the air source 14. The variables X and Y are dependent on the size of window, type of glass (if infrared or UV protected), cross sectional area of the duct air passages, thickness of glass, dual pane versus single pane for the glass, distance from point of discharge to glass, insulation type and thickness of the duct air passages. Also the discharge openings can be scaled up depending on the size of the vehicle.

Referring back to FIG. 1, the window defogging system 10 also includes a control module 28 that is configured to provide conditioned air from the air source 14 through the first air diffuser 16 and the second air diffuser 18 in response to input data indicating at least one operating condition of window fogging and window icing. The control module 28 may comprise a computing device such as a dedicated microprocessor or an electronic control unit (ECU) operating in accordance with instructions from appropriate control software. Thus, the control module 28 may comprise one or more processors, one or more memories, and one or more network interfaces all in communication with each other over a communication bus.

As illustrated in FIG. 1, the control module 28 includes at least one data input 30 operatively connected to at least one sensor or monitoring device 32. That sensor or monitoring device 32 may be selected from a group of sensor or monitoring devices consisting of an ambient humidity sensor, a passenger compartment humidity sensor, a current precipitation sensor, an ambient temperature sensor, a passenger compartment temperature sensor, a window condition monitoring device and combinations thereof. Ambient humidity sensors, passenger compartment humidity sensors, precipitation sensors, such as rain sensors, ambient temperature sensors, passenger compartment temperature sensors and window condition monitoring devices such as individual video cameras on each window of the motor vehicle are known in the art. These sensors or monitoring devices 32 allow the control module 28 to monitor ambient weather conditions, passenger compartment environmental conditions and the actual surface of one or more windows of the motor vehicle for fogging or icing. The control module 28 is then configured to clear the fog or ice from the windows by directing air from the air source 14 through the first air diffuser 16 and/or the second air diffuser 18.

More specifically, as should be appreciated from reviewing FIGS. 1-4, the first air diffuser 16 may be positioned in an interior cavity of a first door 34 of the motor vehicle 12 with the first plurality of air guides 20 oriented along a first base 36 of a first window 38 of the first door. Similarly, the second air diffuser 18 may be positioned in a cavity 40 in a second door 42 of the motor vehicle 12 with the second plurality of air guides 22 oriented along a second base 44 of a second window 46 in the second door.

As illustrated in FIG. 1, the control module 28 may be operatively connected to a first airflow control valve 48 for controlling airflow from the air source 14 to the first air diffuser 16. Further, the control module 28 may be operatively connected to a second airflow control valve 50 for controlling the flow of air from the air source 14 to the second air diffuser 18. More specifically, as illustrated in FIG. 1, air from the second airflow control valve 50 is delivered to the second air diffuser 18 through an air delivery conduit 52 provided in the first door 34. That air delivery conduit 52 has a first end 54 in communication with the air source 14 and a second end 56 in communication with the second air diffuser 18.

When fogging or icing is detected on the first window 38, by the sensor/monitoring device 32, control module 28 responds by opening the first airflow control valve 48 so that conditioned air is delivered from the air source 14 to the first air diffuser 16. That conditioned air is then directed through the first plurality of air guides 20 of the first air diffuser 16 across the first base 36 of the first window 38. Accordingly, the conditioned air rises upward across the face of the first window 38 (note action arrows A) demisting and/or de-icing the first window.

When the sensor/monitoring device 32 detects fog or ice on the second window 46, the control module 28 is configured to open the second airflow control valve 50 so that conditioned air is delivered from the air source 14 through the air delivery conduit 52 to the second air diffuser 18. That conditioned air is then directed through the second plurality of air guides 22 in the second air diffuser across the second base 44 of the second window 46. The conditioned air then rises upwardly (note action arrows B) along the surface of the second window 46 demisting and de-icing the second window. When fogging and icing of the first window 38 and the second window 46 are detected by the sensor/monitoring device 32, both airflow control valves 48, 50 are opened to direct conditioned air to both air diffusers 16, 18 for defogging or de-icing both windows.

Consistent with the above description, a method of window defogging is provided. That method may be broadly described as including the steps of delivering air such as conditioned air from the air source 14 to the first air diffuser 16 having a first plurality of air guides 20 increasing in cross sectional area in proportion to increasing distance away from the air source and directing that air from the first plurality of air guides upwardly along the first base 36 of the first window 38 of the motor vehicle 12.

The method may also include the steps of delivering air such as conditioned air from the air source 14 to the second air diffuser 18 having a second plurality of air guides 22 increasing in cross sectional area in proportion to increasing distance away from the air source and directing that air from the second plurality of air guides upwardly along the second base 44 of the second window 46 of the motor vehicle 12.

As previously disclosed, the method may also include the step of conditioning the air prior to delivering the air to the first air diffuser 16 and the second air diffuser 18. In addition, the method may include the step of configuring the control module 28 of the window defogging system 10 to deliver the air to the first air diffuser 16 and the second air diffuser 18 in response to input data indicating at least one operating condition of window fogging and window icing. Toward this end the method includes monitoring, by at least one device 32, at least one parameter selected from a group consisting of ambient humidity, passenger compartment humidity, current precipitation, ambient temperature, passenger compartment temperature, current window condition and combinations thereof. Data from the at least one or more devices 32 is sent to the control module 28 through the at least one data input 30.

In the illustrated embodiment, the method further includes providing the first air diffuser 16 in the first door 34 of the motor vehicle 12 and providing the second air diffuser 18 in the second door 42 of the motor vehicle. Further, the method includes conveying the air to the second air diffuser 18 through the air delivery conduit 52 in the first door 34.

Numerous benefits are provided by the window defogging system 10. By increasing the cross sectional area of the air discharge apertures 24₁-24₇ of the first plurality of air guides 20 and the air discharge apertures 26₁-26₇ of the second plurality of air guides 22 in proportion to the distance those air discharge apertures are away from the air source 14, it is possible to provide the necessary volume of conditioned air from the air source 14 to quickly and efficiently defog and de-ice the first and second windows 38, 46 consistently across the width of the windows. While the window defogging system 10 is useful for substantially any motor vehicle 12, it is particularly advantageous for use in autonomous commercial motor vehicles where there is a continuous change of passengers entering and exiting a vehicle and those passengers may introduce different levels of moisture into the passenger compartment.

The foregoing has been presented for purposes of illustration and description. It is not intended to be exhaustive or to limit the embodiments to the precise form disclosed. Obvious modifications and variations are possible in light of the above teachings. For example, in the illustrated embodiment, the window defogging system 10 includes a first air diffuser 16 for defogging a front or first window 38 in a first door 34 and a second air diffuser 18 for defogging a second window 46 in a second door 42. It should be appreciated that the window defogging system 10 may include as many air diffusers as there are windows to be defogged and whether or not those windows are in doors or not. Further, while the illustrated embodiment includes individual airflow control valves 48, 50 for controlling airflow to each of the individual air diffusers 16, 18, the window defogging system 10 need only include one airflow control valve.

Such a window defogging system 10 would provide conditioned air from the air source 14 to all air diffusers 16, 18 at all windows 38, 46 when fogging or icing of the windows is detected by the sensor/monitoring device 32. All such modifications and variations are within the scope of the appended claims when interpreted in accordance with the breadth to which they are fairly, legally and equitably entitled.

What is claimed:

1. A window defogging system for a motor vehicle, comprising:
an air source; and
a first air diffuser in communication with said air source, said first air diffuser including a first plurality of air guides increasing in cross sectional area in proportion to increasing distance away from said air source.

2. The window defogging system of claim 1, further including a second air diffuser, said second air diffuser including a second plurality of air guides increasing in cross sectional area in proportion to increasing distance away from said air source.

3. The window defogging system of claim 2, further including an air delivery conduit having a first end in communication with said air source and a second end in communication with said second air diffuser.

4. The window defogging system of claim 3, wherein said air source is an HVAC system providing conditioned air for distribution through said first air diffuser and said second air diffuser.

5. The window defogging system of claim 4, further including a control module configured to provide conditioned air through said first air diffuser and said second air diffuser in response to input data indicating at least one of window fogging and window icing.

6. The window defogging system of claim 5, wherein said control module is connected to at least one device selected from a group consisting of an ambient humidity sensor, a passenger compartment humidity sensor, a precipitation sensor, an ambient temperature sensor, a passenger compartment temperature sensor, a window condition monitoring device and combinations thereof.

7. The window defogging system of claim 6, wherein said first air diffuser is positioned in a first door of said motor vehicle with said first plurality of air guides oriented along a first base of a first window of said first door.

8. The window defogging system of claim 7, wherein said second air diffuser is positioned in a second door of said motor vehicle with said second plurality of air guides oriented along a second base of a second window of said second door.

9. The window defogging system of claim 8, wherein said air delivery conduit extends through said first door.

10. The window defogging system of claim 2, further including a control module configured to provide conditioned air through said first air diffuser and said second air diffuser in response to input data indicating at least one of window fogging and window icing.

11. The window defogging system of claim 10, wherein said control module is connected to at least one device selected from a group consisting of an ambient humidity sensor, a passenger compartment humidity sensor, a precipitation sensor, an ambient temperature sensor, a passenger compartment temperature sensor, a window condition monitoring device and combinations thereof.

12. A method of window defogging, comprising:
delivering air from an air source to a first air diffuser having a first plurality of air guides increasing in cross sectional area in proportion to increasing distance away from said air source; and
directing said air from said first plurality of air guides upwardly along a first base of a first window of a motor vehicle.

13. The method of claim 12, including:
delivering said air from said air source to a second air diffuser having a second plurality of air guides increasing in cross sectional area in proportion to increasing distance away from said air source; and
directing said air from said second plurality of air guides upwardly along a second base of a second window of said motor vehicle.

14. The method of claim 13, including conditioning said air prior to delivering said air to said first air diffuser and said second air diffuser.

15. The method of claim 14, including configuring a control module to deliver said air to said first air diffuser and said second air diffuser in response to input data indicating at least one of window fogging and window icing.

16. The method of claim 15, including monitoring, by at least one device, at least one parameter selected from a group consisting of ambient humidity, passenger compartment humidity, current precipitation, ambient temperature, passenger compartment temperature, current window condition and combinations thereof.

17. The method of claim 16, including providing said first air diffuser in a first door of said motor vehicle.

18. The method of claim 17, including providing said second air diffuser in a second door of said motor vehicle.

19. The method of claim 18, including conveying said air to said second air diffuser through an air delivery conduit in said first door.

20. A motor vehicle incorporating the window defogging system of claim 1.
